(19) United States
(12) Patent Application Publication
(10) Pub. No.: US 2011/0294715 A1
(43) Pub. Date: Dec. 1, 2011

(54) ENCAPSULATES

(76) Inventors: Johan SMETS, Lubbeek (BE); Susana Fernandez Prieto, Benicarlo-Castellon (ES); Nianxi Yan, Appleton, WI (US)

(21) Appl. No.: 13/116,133

(22) Filed: May 26, 2011

Related U.S. Application Data
(60) Provisional application No. 61/348,458, filed on May 26, 2010.
(60) Provisional application No. 61/367,979, filed on Jul. 27, 2010.

(51) Int. Cl. C11D 17/08

(52) U.S. Cl. 510/375; 510/475; 510/392

(57) ABSTRACT

The present application relates to encapsulated, solid, water soluble benefit agents and products comprising such encapsulates, as well as processes for making and using such encapsulates and products comprising such encapsulates. In one aspect, the present application relates to a melamine formaldehyde and/or urea formaldehyde encapsulation process that offers a solution to the current encapsulation technologies issues.

### CROSS-REFERENCES TO RELATED APPLICATIONS

This application claims priority under 35 U.S.C. §119(e) to U.S. Provisional Application Ser. No. 61/348,458 filed May 26, 2010, and U.S. Provisional Application Ser. No. 61/367,979 filed Jul. 27, 2010.

### FIELD OF INVENTION

The present application relates to encapsulated, water soluble benefit agents and products comprising such encapsulates, as well as processes for making and using such encapsulates and products comprising such encapsulates.

### BACKGROUND OF THE INVENTION

Products, for example, consumer products may comprise one or more water soluble benefit agents that can provide a desired benefit to such product and/or a situs that is contacted with such a product—for example stain removal and/or bleaching. Unfortunately such benefit agents may be degraded by or degrade components of a product before such product is used. Thus, a protection system that protects the components of a product is desired. Protection systems include coating processes such as starch encapsulation and agglomeration. Applicants recognized that water soluble benefit agents may be encapsulated via water-in-oil emulsions using interfacial polymerization between two monomers—one that is water-soluble and the other oil-soluble. Such method typically involves droplet precipitation and produces clumped capsules because some of the water-soluble monomers partition into the oil phase, and react with oil-soluble monomer in the bulk oil phase rather than at the oil-water interface, causing clumping of capsules. Moreover, monomers used for interfacial polymerization encapsulation processes tend to react with the water soluble benefit agent that needs to be encapsulated unless it is protected. While such processes offer certain benefits, new protection processes that allow for triggered benefit agent release are desired. While melamine formaldehyde and/or urea formaldehyde encapsulating technologies exist, Applicants recognized that such technologies do not provide the desired benefit agent loads as such technologies typically require the use of a hydrophobic solvent and micronized, solid water soluble benefits agents or multiple core emulsions. In short, Applicants recognized the source of the problem and in the present specification disclose a solution to such problems as well as an effective encapsulation process that employs such solution. In addition, Applicants recognized the importance of having, among other things the correct encapsulate fracture strength. Thus, encapsulates made by the aforementioned process and products comprising such encapsulates are disclosed. Surprisingly, such encapsulates are stable in such consumer products, yet release the majority of their water soluble benefit agent when such consumer product is used as intended.

### SUMMARY OF THE INVENTION

The present application relates to encapsulated, water soluble benefit agents and products comprising such encapsulates, as well as processes for making and using such encapsulates and products comprising such encapsulates. In one aspect, the present application relates to a melamine formaldehyde and/or urea formaldehyde encapsulation process that offers a solution to current encapsulation technologies issues.

### DETAILED DESCRIPTION OF THE INVENTION

### Definitions

As used herein “consumer product” means baby care, beauty care, fabric & home care, family care, feminine care, health care, or devices generally intended to be used in the form in which it is sold. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshing), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals.

As used herein, the term “cleaning and/or treatment composition” is a subset of consumer products that includes, unless otherwise indicated, beauty care, fabric & home care products. Such products include, but are not limited to, products for treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for treating fabrics, hard surfaces and any other surfaces in the area of fabric and home care, including: air care including air fresheners and scent delivery systems, car care, dishwashing, fabric conditioning (including softening and/or freshing), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners including toilet bowl cleaners; hair shampoos and hair-rinses; shower gels, fine fragrances and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists all for consumer or/and institutional use; and/or methods relating to oral care including toothpastes, tooth gels, tooth rinses, denture adhesives, tooth whitening.

As used herein, the term “fabric and/or hard surface cleaning and/or treatment composition” is a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshing that may be in liquid, solid and/or dryer sheet form; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products which are applicable may be in standard, concentrated or even highly concentrated form even to the extent that such products may in certain aspect be non-aqueous.

As used herein, articles such as “a” and “an” when used in a claim, are understood to mean one or more of what is claimed or described.

As used herein, the terms “include”, “includes” and “including” are meant to be non-limiting.

As used herein, the term “solid” includes granular, powder, bar and tablet product forms.

As used herein, the term “fluid” includes liquid, gel, paste and gas product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Consumer Products

In one aspect, a consumer product comprising particles, said particles comprising a shell material and a core material, said shell material comprising a material selected from cross-linked melamine formaldehyde, cross-linked urea formaldehyde and mixtures thereof and encapsulating said core material, said core material comprising, a solution comprising water and a water soluble benefit agent having a water solubility of at least 10 g/liter, from about 10 g/liter to about 800 g/liter, from about 50 g/liter to about 600 g/liter, from about 100 g/liter to about 500 g/liter or even from about 150 g/liter to about 400 g/liter; at least 75%, 85% or even 90% of said particles having a fracture strength of from about 0.1 MPa to about 5 MPa, from about 0.2 MPa to about 3 MPa, from about 0.2 MPa to about 2.0 MPa, or even from about 0.2 MPa to about 1.2 MPa; and a consumer product adjunct ingredient is disclosed.

In one aspect of said consumer product, said core material may comprise, based total core weight, from about 0.01% to about 80%, from about 0.1% to about 50%, from about 1% to about 25% or from about 5% to about 15% of said water soluble benefit agent.

In one aspect of said consumer product, said particle may comprise, based total particle weight, from about 1% to about 95%, from about 1% to about 95%, from about 5% to about 80% or from about 5% to about 50% of said core material.

In one aspect of said consumer product, said consumer product may comprise, based total consumer product weight, from about 0.01% to about 50%, from about 0.1% to about 20%, from about 0.2% to about 15% or from about 0.2% to about 5% of said particle.

In one aspect of said consumer product, said water soluble benefit agent may comprise a material selected from the group consisting of a metal catalyst, a hydrogen peroxide source, an enzyme and mixtures thereof, wherein:
a. said metal catalyst may comprise a material selected from the group consisting of dichloro-1,4-diethyl-1,4,8,11-tetraaazabicyclo[6.6.2]hexadecane manganese(II); dichloro-1,4-dimethyl-1,4,8,11-tetraaazabicyclo[6.6.2]hexadecane manganese(II) and mixtures thereof;
b. said hydrogen peroxide source may comprise a material selected from the group consisting of a perborate, a percarbonate a peroxyhydrate, a peroxide, a persulfate, hydrogen peroxide and mixtures thereof, in one aspect said hydrogen peroxide source may comprise sodium perborate, in one aspect said sodium perborate may comprise a mono- or tetra-hydrate, sodium pyrophosphate peroxyhydrate, urea peroxyhydrate, trisodium phosphate peroxyhydrate or sodium peroxide and mixtures thereof; and
c. said enzyme may comprise a material selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

In one aspect of said consumer product, said particle may have a benefit agent release of at least 10%, at least 25%, at least 35%, from 50% to about 100%, from 65% to about 95%, or even from 85% to about 95% of said benefit agent after 10 minutes, 8 minutes or even 5 minutes of use of such consumer product containing said particles.

In one aspect of said consumer product, wherein at least 75%, 85% or even 90% of said particles may have a particle size of from about 1 microns to about 100 microns, about 5 microns to 80 microns, from about 6 microns to about 50 microns, or even from about 10 microns to about 30 microns.

In one aspect of said consumer product, wherein at least 75%, 85% or even 90% of said particles may have a particle wall thickness of from about 5 nm to about 250 nm, from about 25 nm to about 180 nm, or even from about 30 nm to about 150 nm.

In one aspect of said consumer product, said consumer product may comprise a material selected from the group consisting of a formaldehyde scavenger, a structurant, an anti-agglomeration agent and mixtures thereof.

In one aspect of said consumer product, said consumer product may comprise, based total consumer product weight, less than 85%, less than 60, less than 40%, less than 20% total water.

In one aspect of said consumer product, said consumer product may comprise, based on total consumer product weight, from about 1% to about 85%, from about 3% to about 60%, from about 5% to about 40%, from about 5% to about 20% total water.

In one aspect of said consumer product, said consumer product may be a highly compacted consumer products, including highly compacted fabric and hard surface cleaning and/or treatment compositions, for example highly compacted detergents that may be solids or fluids, and may comprise water, based on total consumer product weight, at levels of from about 0.001% to about 20%, from about 0.01% to about 10%, from about 0.05% to about 5%, from about 0.1% to about 0.5%.

In one aspect of said consumer product, said consumer product may comprise a perfume delivery or any combination of perfume delivery systems described, for example, in USPA 2007/0275866 A1: Molecule-Assisted Delivery (MAD) systems; Fiber-Assisted Delivery (FAD) systems; Amine Assisted Delivery (AAD; Cyclodextrin Delivery System (CD); Starch Encapsulated Accord (SEA); Inorganic Carrier Delivery System (ZIC); Pro-Perfume (PP) including Amine Reaction Products (ARPs); and other Polymer Assisted Delivery (PAD) systems.

In addition to the foregoing aspects of said consumer product, aspects of Applicants consumer products may comprise/have any combination of characteristics and/or parameters disclosed in the present specification.

### Process of Making Consumer Products

A process of making a consumer product, comprising a consumer product adjunct material and a particle comprising a shell and a core material encapsulated by said shell is disclosed, said process may comprise:
a) providing an aqueous phase comprising water and a water soluble benefit agent;
b) dissolving or dispersing shell-forming material comprising water-soluble or water-dispersible prepolymers, oligomers or monomers into the aqueous phase;
c) providing a water-immiscible phase comprising a curable monomer or oligomer and at least one emulsifier;
d) dispersing the aqueous phase into an excess of the water immiscible phase, nonreactive with the shell-forming prepolymers, oligomers or monomers, under high shear agitation to form droplets of the aqueous phase dispersed in the water immiscible phase, a water-oil interphase resulting at the interphase of the aqueous and water-immiscible phases;
e) adding at least one water insoluble polymerization catalyst reactive with the shell forming prepolymers, oligomers or monomers present in the aqueous phase;
f) forming particles by initiating polycondensation of the monomers, oligomers or prepolymers in the dispersed aqueous phase by heating to precipitate the monomers, oligomers and prepolymers from the aqueous phase at the water-oil interphase thereby forming shell material at least partially encapsulating the droplets of the aqueous phase and core material
g) combining said particles with said consumer product adjunct material.

In one aspect of said process of making a consumer product, said particles may comprise microcapsules and the shell material encapsulates the droplets of the aqueous phase and the water soluble benefit agent.

In one aspect of said process of making a consumer product, said water soluble benefit agent comprises a material selected from the group consisting of a metal catalyst, a hydrogen peroxide source, an enzyme and mixtures thereof.

In one aspect of said process of making a consumer product, said water insoluble polymerization catalyst t may comprise an acid, a phase transfer catalyst, and a proton transfer catalyst.

In one aspect of said process of making a consumer product, said water insoluble polymerization catalyst comprises sulfonic acid.

In one aspect of said process of making a consumer product, said water insoluble polymerization catalyst may be selected from the group consisting of mono- or di-alkylbenzene sulfonic acid, alkaryl sulfonic acid, alkali metal salts of hydrocarbon sulfonic acids, oil soluble sulfonic acids, salts of hydrophobic sulfonic acids, and halogenated sulfonic acid copolymers.

In one aspect of said process of making a consumer product, said water insoluble polymerization catalyst may comprise a fluorinated sulfonic acid copolymer particle or acid cation ion exchange particle.

In one aspect of said process of making a consumer product, at least one of said shell-forming prepolymers may be also dispersed into the water immiscible solvent.

In one aspect of said process of making a consumer product, said shell-forming prepolymer may comprise urea formaldehyde, melamine formaldehyde, novolac, and phenolic resin.

In one aspect of said process of making a consumer product, said water immiscible phase may comprise in addition an organic solvent.

In one aspect of said process of making a consumer product, said process of making a consumer product may comprise an additional step of combining the particles with an adjunct material.

In one aspect of said process of making a consumer product, said process of making a consumer product may comprise an additional step of decanting the formed particles from the water immiscible phase.

The present invention provides an improved process for encapsulating water-soluble benefit agents via water-in-oil emulsions. The wall deposition occurs primarily from the internal aqueous phase onto the water-oil interface, and thus forms a population of individual capsules encapsulating water and core material. A wall component can be positioned in the other phase to reactively cooperate in wall formation as an alternative mechanism. The process can be generally summarized as:
a. providing an aqueous phase comprising a water soluble benefit agent to be encapsulated. One or more pre-polymers such as melamine-formaldehyde or urea-formaldehyde, or other aminoplast are dissolved or dispersed in the aqueous phase (pre-polymers include for purposes hereof, monomers and oligomers);
b. preparing a water-in-oil emulsion by dispersing the aqueous phase into a water-immiscible (oil) phase comprising one or more UV curable monomers or oligomers, one or more emulsifiers and a catalyst;
c. initializing polycondensation of the pre-polymers in the aqueous phase by heating to form polymers, and force precipitation of the polymers from the aqueous internal phase droplets onto the water-oil interface to form a wall, thus forming microcapsules. This can be achieved by heating the catalyst in the oil phase to induce the polycondensation reaction at or near the oil-water interface, and thereby forming a shell to encapsulate the aqueous droplet. The catalyst may be an acid, such as water insoluble sulfonic acids, a phase transfer catalyst, or a proton transfer catalyst. Examples of catalyst include organo sulfonic acids organo sulfuric acids or organo phosphoric acids. These acids can be used in solid or liquid form. In solid form, a useful form is as polymeric copolymers such as fluorinated sulfonic acid copolymers, where the sulfonic group is chemically active. Dupont Nafion™ powders are an example. Other useful catalysts are ion exchange particles such as Dowex™ acid cation ion exchange spherical powders.

In a broad sense, the present invention teaches novel particles having a shell material at least partially surrounding a core material, which particles preferably are microcapsules and encapsule an aqueous phase comprising water and a water soluble benefit agent core material. The process comprises, providing an aqueous phase comprising a core material. Shell-forming water-soluble or water-dispersible prepolymers, oligomers or monomers are dissolved or dispersed into the aqueous phase. The amount of prepolymer for forming the capsule wall is 2 to 40 wt %, and more preferably from 5 to 20 wt % of the weight of the aqueous phase. A separate water-immiscible phase is provided comprising at least one curable monomer or oligomer, at least one emulsifier, and at least one catalyst. The aqueous phase is dispersed into an excess of the water immiscible phase under high shear agitation to form droplets of the aqueous phase dispersed in the water immiscible phase. A water-oil interphase results at the interphase of the aqueous and water-immiscible phases. Polycondensation of the monomers, oligomers and prepolymers in the dispersed aqueous phase is initiated by heating to thereby precipitate the monomers, oligomers and prepolymers from the aqueous phase at the water-oil interphase thereby forming wall material encapsulating the droplets of the aqueous phase. The result is formation of microcapsules.

In an alternative embodiment, organic solvent can be blended as part of the water immiscible phase. In a yet further embodiment, the water immiscible phase is selected to comprise at least one organic solvent, at least one emulsifier, and at least one polymerization catalyst.

With these alternatives, the particles or capsules are optionally either decanted and transferred to another carrier, or another carrier is added or the particles are used as part of a mixture.

For many emulsifiers, hydrophobic-lipophilic balance numbers are reported in the literature and can be a useful guide in selection of emulsifier.

TABLE1
HLB—hydrophilic-lipophilic balance

| Emulsifier | HLB value |
|---|---|
| Glycerol monostearate | 3.8 |
| Diglycerol monostearate | 5.5 |
| Tetraglycerol monostearate | 9.1 |
| Succinic acid ester of monoglycerides | 5.3 |
| Diacetyl tartaric acid ester of monoglycerides | 9.2 |
| Sodium stearoyl-2-lactylate | 21.0 |
| Sorbitan tristerate | 2.1 |
| Sorbitan monostearate | 4.7 |
| Sorbitan monooleate | 4.3 |
| Poloxyethylene sorbitan monostearate | 14.9 |
| Propylene glycol monostearate | 3.4 |
| Polyoxyethylene sorbitan monooleate | 15.0 |

Typical water in oil emulsifiers generally have an HLB (hydrophilic-lipophilic balance) value of 3 to 6. HLB values above about 8 generally are used to promote oil in water emulsions.

The capsules obtained by the process of the invention are suspended in the oil or water immiscible phase. When dry powders of the microcapsules are needed, the oil can be removed by some traditional methods, such as filtration, decanting, washing with a suitable solvent, etc. The particles or microcapsules can be optionally combined with various adjunct materials.

Useful monomers or oligomers useful as the “oil” or water-immiscible phase in the invention are mono-, di- or poly-functional acrylate esters, methacrylate esters, urethane acrylate esters, urethane methacrylate esters, epoxy acrylate eaters, or epoxy methacrylate eaters. They can be used alone or in combination as blends. The monomer and/or oligomer blend is preferably selected to be a free flowing liquid, meaning preferably a viscosity of less than 500 centipoise (Cp). Centipoise is equivalent to milliPascal-second units (milliPascal-second). Viscosity parameters herein are understood as measured at 25° C. unless otherwise indicated.

In one aspect, the viscosity of the monomer and/or blend is less than 100, and even more preferably less than about 25 Cp (milliPascal-second).

Useful monofunctional acrylates, methacrylates and urethane acrylates, urethane methacrylates include, by way of illustration and not limitation, monomers and oligomers of alkyl acrylate, aralkyl acrylate, cycloalkyl acrylate, alkoxy acrylate, cycloalkoxy acrylate, bicycloalkyl acrylate, alkoxy (alkoxy)ₙ acrylate, alkyl methacrylate, polyalkene(meth)acrylate, aralkyl methacrylate, cycloalkyl methacrylate, alkoxy methacrylate, bicycloalkyl methacrylate, cycloalkoxy methacrylate, and alkoxy (alkoxy)ₙ methacrylate. The alkyl moieties should be selected preferably of 1 to 16 carbons, the cycloalkyl moieties from 4 to 8 carbons, and n is an integer from 1 to 6.

More particularly monofunctional acrylates, methacrylate or urethane acrylates or methacrylates can be selected from, by way of illustration and not limitation, n-pentyl acrylate, 2-methyl butyl acrylate, 2-ethylhexyl acrylate, n-octyl acrylate, n-decyl acrylate, n-dodecyl acrylate, lauryl methacrylate, lauryl acrylate, stearyl acrylate, stearyl methacrylate, 2-ethylhexyl methacrylate, n-octyl methacrylate, iso-octyl acrylate, iso-octyl methacrylate, isononyl acrylate, isodecyl acrylate, isobornyl acrylate, isobornyl methacrylate, 2-ethoxyethyl methacrylate; butyl diglycol methacrylate; tetrahydrofurfuryl acrylate; tetrahydrofurfuryl methacrylate; furfuryl methacrylate 2-phenoxyethyl acrylate, isohexyl acrylate; tridecyl acrylate; tridecyl methacrylate; ethoxylated nonyl phenol acrylate and the like and mixtures thereof.

Useful di-functional monomers for example can be selected from the group of monomers and oligomers consisting of alkene glycol dimethacrylate, alkyl dimethacrylate, alkyldiol dimethacrylate, alkoxy alkanol diacrylate, trialkanol triacrylate, alkoxy(alkoxy)ₙ alkyl triacrylate, alkoxy (alkoxy)ₙ alkyl dimethacrylate, aralkyl dimethacrylate, cycloalkyl dimethacrylate, alkoxy dimethacrylate, bicycloalkyl dimethacrylate, cycloalkoxy dimethacrylate, alkene glycol diacrylate, alkyl diacrylate, alkyldiol diacrylate, alkoxy alkanol dimethacrylate, trialkanol trimethacrylate, alkoxy (alkoxy)ₙ alkyl trimethacrylate, alkoxy (alkoxy)ₙ alkyl diacrylate, aralkyl diacrylate, cycloalkyl diacrylate, alkoxy diacrylate, bicycloalkyl diacrylate, cycloalkoxy diacrylate, wherein the alkyl and alkene moieties are of 1 to 16 carbons, the cycloalkyl moieties are of 4 to 8 carbons, n is an integer from 1 to 6. Aromatic polyether urethane (meth)acrylates, aliphatic polyester, aliphatic urethane acrylate including alkyl, alkenyl or aryl substituted or unsubstituted urethane acrylates and epoxy acrylates can also be advantageously employed.

More specifically, by way of illustration and not limitation, the monomers can be selected from any of hexyl dimethacrylate; triethylene glycol dimethacrylate; ethylene glycol dimethacrylate; tetraethylene glycol dimethacrylate; polyethylene glycol dimethacrylate; 1,3 butylene glycol diacrylate; 1,4-butanediol dimethacrylate; 1,4-butanediol diacrylate; diethylene glycol diacrylate; diethylene glycol dimethacrylate; 1,6 hexanediol diacrylate; 1,6 hexanediol dimethacrylate; neopentyl glycol diacrylate; neopentyl glycol dimethacrylate, polyethylene glycol diacrylate; tetraethylene glycol diacrylate; triethylene glycol diacrylate; 1,3 butylene glycol dimethacrylate; tripropylene glycol diacrylate; ethoxylated bisphenol diacrylate; ethoxylated bisphenol dimethyacrylate; dipropylene glycol diacrylate; alkoxylated hexanediol diacrylate; alkoxylated cyclohexane dimethanol diacrylate; propoxylated neopentyl glycol diacrylate, trimethylolpropane trimethacrylate; trimethylolpropane triacrylate, pentaerythritol triacrylate, ethoxylated trimethylolpropane triacrylate, propoxylated trimethylolpropane triacrylate, propoxylated glyceryl triacrylate, ditrimethylolpropane tetraacrylate, dipentaerythritol pentaacrylate, ethoxylated pentaerythritol tetraacrylate, and the like, and mixtures thereof.

Various additives, including viscosity modifiers, gelling agents, fillers, plasticizers, binders, adjuvants, and diluents can be used to modify either the wall material, or the aqueous internal phase, to render them more suitable for particular end uses.

Binders, such as polyvinyl alcohol, or various latexes, carboxymethyl cellulose, waxes, wetting agents, and plasticizers such as phthalate esters, can also be added. Viscosity modifiers such as epoxy acrylates can be advantageously employed. Any material which does not dissolve the microcapsule wall may ordinarily be optionally employed.

Optionally, depending on the application, in alternative embodiments, fillers and pigments may be included. Fillers may be powdered, granular, particulate or fibrous.

In the invention the water immiscible phase solution with catalyst and emulsifier is prepared as the continuous phase or phase in excess. The water immiscible phase solution comprises a water immiscible solvent as described above. The aqueous phase solution with core material and wall forming prepolymer is dispersed into the water immiscible solvent thereby forming droplets of the aqueous phase solution in the water immiscible phase solution. The result is an unconventional water in oil (w/o) emulsion.

Polycondensation by heating of the prepolymers forms wall material at or near the interface of the water immiscible solvent and droplets of aqueous phase solution thereby forming microcapsules.

Alternatively in these examples the core can be substituted such as by being selected to be a water soluble or water dispersible material selected from any of the various core materials taught in this specification. The core material should be water soluble or water dispersible but is not otherwise limited in the invention.

### Adjunct Materials

For the purposes of the present invention, the non-limiting list of adjuncts illustrated hereinafter are suitable for use in the instant compositions and may be desirably incorporated in certain embodiments of the invention, for example to assist or enhance performance, for treatment of the substrate to be cleaned, or to modify the aesthetics of the composition as is the case with perfumes, colorants, dyes or the like. It is understood that such adjuncts are in addition to the components supplied by the recited particle. The precise nature of these additional components, and levels of incorporation thereof, will depend on the physical form of the composition and the nature of the operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, external structuring system, fabric softeners, carriers, hydrotropes, processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

Each adjunct ingredient is not essential to Applicants' compositions. Thus, certain embodiments of Applicants' compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, external structuring system, fabric softeners, carriers, hydrotropes, processing aids and/or pigments. It is understood that such adjuncts may form a product matrix that is combined with the encapsulates disclosed herein to form a finished consumer product. Generally, when one or more adjuncts are present, such one or more adjuncts may be present as detailed below:

Surfactants—The compositions according to the present invention can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the cleaning compositions to about 99.9%, to about 80%, to about 35%, or even to about 30% by weight of the cleaning compositions.

Builders—The compositions of the present invention can comprise one or more detergent builders or builder systems. When present, the compositions will typically comprise at least about 1% builder, or from about 5% or 10% to about 80%, 50%, or even 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methyl-enephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936, and 5,595,967.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include manganese, iron and chromium. Suitable MRL's herein are a special type of ultra-rigid ligand that is cross-bridged such as 5,12-diethyl-1,5,8,12-tetraazabicyclo[6.6.2]hexa-decane.

Suitable transition metal MRLs are readily prepared by known procedures, such as taught for example in WO 00/32601, and U.S. Pat. No. 6,225,464.

External structuring system—The composition of the present invention may comprise from 0.01% to 5% or even from 0.1% to 1% by weight of an external structuring system. The external structuring system may be selected from the group consisting of:

(i) non-polymeric crystalline, hydroxy-functional structurants and/or

(ii) polymeric structurants

Such external structuring systems may be those which impart a sufficient yield stress or low shear viscosity to stabilize a fluid laundry detergent composition independently from, or extrinsic from, any structuring effect of the detersive surfactants of the composition. They may impart to a fluid laundry detergent composition a high shear viscosity at 20⁻¹ at 21° C. of from 1 cps to 1500 cps and a viscosity at low shear (0.05 s⁻¹ at 21° C.) of greater than 5000 cps. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1 s⁻¹ to 25 s⁻¹ in 3 minutes time at 21° C. In one embodiment, the compositions may comprise from 0.01 to 1% by weight of a non-polymeric crystalline, hydroxyl functional structurant. Such non-polymeric crystalline, hydroxyl functional structurants may comprise a crystallizable glyceride which can be pre-emulsified to aid dispersion into the final unit dose laundry detergent composition. Suitable crystallizable glycerides include hydrogenated castor oil or “HCO” or derivatives thereof, provided that it is capable of crystallizing in the liquid detergent composition.

Unit dose laundry detergent compositions may comprise from 0.01 to 5% by weight of a naturally derived and/or synthetic polymeric structurant. Suitable naturally derived polymeric structurants include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Suitable synthetic polymeric structurants include: polycarboxylates, polyacrylates, hydrophobically modified ethoxylated urethanes, hydrophobically modified non-ionic polyols and mixtures thereof. In one aspect, the polycarboxylate polymer may be a polyacrylate, polymethacrylate or mixtures thereof. In another aspect, the polyacrylate may be a copolymer of unsaturated mono- or di-carbonic acid and C₁-C₃₀ alkyl ester of the (meth)acrylic acid. Such copolymers are available from Noveon inc under the tradename Carbopol® Aqua 30.

### Method of Use

Certain of the consumer products disclosed herein can be used to clean or treat a situs inter alia a surface or fabric. Typically at least a portion of the situs is contacted with an embodiment of Applicants'consumer product, in neat form or diluted in a liquor, for example, a wash liquor and then the situs may be optionally washed and/or rinsed. In one aspect, a situs is optionally washed and/or rinsed, contacted with an aspect of the consumer product and then optionally washed and/or rinsed. For purposes of the present invention, washing includes but is not limited to, scrubbing, and mechanical agitation. The fabric may comprise most any fabric capable of being laundered or treated in normal consumer use conditions. Liquors that may comprise the disclosed compositions may have a pH of from about 3 to about 11.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1.

The employing one or more of the aforementioned methods result in a treated situs.

### Test Methods

It is understood that the test methods that are disclosed in the Test Methods Section of the present application should be used to determine the respective values of the parameters of Applicants' invention as such invention is described and claimed herein.

(1) Fracture Strength
a.) Place 1 gram of particles previously cleaned with hexane in 1 liter of distilled deionized (DI) water.
b.) Permit the particles to remain in the DI water for 10 minutes and then recover the particles by filtration, using a 60 mL syringe filter, 1.2 micron nitrocellulose filter (Millipore, 25 mm diameter).
c.) Determine the rupture force of 50 individual particles. The rupture force of a particle is determined using the procedure given in Zhang, Z.; Sun, G; “Mechanical Properties of Melamine-Formaldehyde microcapsules,” J. Microencapsulation, vol. 18, no. 5, pages 593-602, 2001. Then calculate the fracture strength of each particle by dividing the rupture force (in Newtons) by the cross-sectional area of the respective spherical particle (πr², where r is the radius of the particle before compression), said cross-sectional area being determined as follows: measuring the particle size of each individual particle using the experimental apparatus and method of Zhang, Z.; Sun, G; “Mechanical Properties of Melamine-Formaldehyde microcapsules,” J. Microencapsulation, vol 18, no. 5, pages 593-602, 2001.
d.) Use the 50 independent measurements from c.) above, and calculate the percentage of particles having a fracture strength within the claimed range fracture strength range.

(2) Particle Size
a) Place 1 gram of particles, previously cleaned with hexane in 1 liter of distilled deionized (DI) water.
b) Permit the particles to remain in the DI water for 10 minutes and then recover the particles by filtration, using a 60 mL syringe filter, 1.2 micron nitrocellulose filter (Millipore, 25 mm diameter).
c) Determine the particle size of 50 individual particles using the experimental apparatus and method of Zhang, Z.; Sun, G; “Mechanical Properties of Melamine-Formaldehyde microcapsules,” J. Microencapsulation, vol. 18, no. 5, pages 593-602, 2001.
d) Use the 50 independent measurements from c.) above, and calculate the percentage of particles having a particle size within the claimed range.

(3) Particle Wall Thickness
All references to Leica Microsystems refer to the Company with Corporate Headquarters located at:
Leica Microsystems GmbH
Ernst-Leitz-Strasse 17-37
35578 Wetzlar
All references to Drummond refer to the Company located at:
Drummond Scientific Company
500 Parkway, Box 700
Broomall, Pa. 19008
All references to Hitachi refer to the Company with Corporate Headquarters located at:
Hitachi High Technologies
24-14, Nishi-Shimbashi 1-chome, Minato-ku,
Tokyo 105-8717, Japan
All references to Gatan refer to the Company with Corporate Headquarters located at:
Gatan, Inc.
5933 Coronado Lane
Pleasanton, Calif. 94588
All references to Quartz refer to the Company with offices located at:
Quartz Imaging Corporation
Technology Enterprise Facility III
6190 Agronomy Rd, Suite 406
Vancouver, B.C. Canada V6T 1Z3

### Materials:

Methylcyclohexane—Alfa Aesar Catalogue Number A16057 or equivalent
Capillary Pipettes—Drummond Catalogue Number 5-000-1005 or equivalent
Flat Specimen Carrier—Leica Microsystems P/N 706897 or equivalent
Copper Washers—Leica Microsystems P/N 706867 or equivalent
Flat Specimen Pod—Leica Microsystems P/N 706839 or equivalent
Loading Device for Flat Specimen Holder—Leica Microsystems P/N 706832 or equivalent
Torque Wrench—Leica Microsystems P/N 870071 or equivalent
Allen Bit, 2 mm—Leica Microsystems P/N 870072 or equivalent
Forceps—Leica Microsystems P/N 840105 or equivalent
Gatan Planchette Collet—Gatan P/N PEP5099
Gatan Planchette Specimen Holder—Gatan P/N PEP1395

### Instruments:

Scanning Electron Microscope—Hitachi Model S-5200 SEM/STEM or equivalent
High Pressure Freezer—Leica Microsystems Model 706802 EM Pact or equivalent
Cryotransfer Device—Gatan Model CT3500 or equivalent
Cryotransfer System—Gatan Model CT2500 or equivalent
Gatan ITC Temperature Controller—Gatan Model ITC502 or equivalent
Image Analysis Software—Quartz PCI Version 5 or equivalent
Sample: Obtain the sample of microcapsules as per the procedure of 1 above entitled “Fracture Strength”. 50 samples are required.

Test Procedure
1) Turn on the Leica Microsystems High Pressure Freezer (Leica Microsystems Model Number 706802).
2) Fill up the methylcyclohexane container on the High Pressure Freezer with methylcyclohexane (Alfa Aesar Cat. #A16057 or equivalent).
3) Fill up the liquid nitrogen dewar on the High Pressure Freezer.
4) Fill the liquid nitrogen bath on the High Pressure Freezer
5) The display on the High Pressure Freezer will show Load Sample on the front panel when the instrument is ready to use.
6) Start the Hitachi Model S-5200 SEM/STEM and set the Accelerating Voltage to 3.0 KV and the Emission Current to 20 μA.
7) Fill the Anti-contaminator Dewar located on the lower right side of the Hitachi Model S-5200 SEM/STEM microscope column with liquid nitrogen.
8) Fill the liquid nitrogen dewar on the Gatan Alto 2500 Cryotransfer System (Gatan Model CT2500). Replenish the liquid nitrogen until the dewar remains full. The device is ready to use when the prepchamber temperature reads below −190° C.
9) Place a copper washer (Leica Microsystems P/N 706867) on top of the flat specimen carrier such that the hole in the washer aligns with the well in the flat specimen carrier.
10) Take a glass capillary pipette (Drummond P/N 5-000-1005 or similar) and insert the provided wire plunger into one end of the pipette
11) Insert the pipette into the microcapsule slurry and withdraw the plunger part way to pull a few microliters of the dispersion into the pipette.
12) Place the tip of the pipette in the well in the flat specimen carrier and push the plunger into the pipette to dispense a small amount of liquid until the well is just slightly overfilled.
13) Insert a 2 mm Allen key bit (Leica Microsystems P/N 870072) into the torque wrench (Leica Microsystems P/N 870071).
14) Using the torque wrench with the bit, loosen the Diamond Locking Screw in the Flat Specimen Pod (Leica Microsystems P/N 706839).
15) Place the Flat Specimen Holder and Copper Washer into the Flat Specimen Pod.
16) Use the torque wrench with the 2 mm Allen key bit to tighten the Diamond Locking Screw in the Flat Specimen Pod onto the specimen until the torque wrench clicks twice.
17) Attach the Loading Device for the Flat Specimen Holder (Leica Microsystems P/N 706832) to the Flat Specimen Pod by screwing it onto the exposed threads of the Diamond Locking Screw.
18) Place the Loading Device for the Flat Specimen Holder with the Flat Specimen Pod onto the EM Pact High Pressure Freezer (Leica Microsystems P/N 706802) and insert it into the High Pressure Freezer.
19) Freeze the specimen using the High Pressure Freezer.
20) Transfer the Flat Specimen Pod to the Unloading Station and unscrew the Loading Device for the Flat Specimen Carrier being careful to keep it immersed in the liquid nitrogen bath.
21) Using the torque wrench, loosen the Diamond Locking Screw.
22) Using tweezers with the tips cooled in liquid nitrogen until the liquid nitrogen stops boiling, remove the Flat Specimen Carrier from the Flat Specimen Pod and place it into a small container in the liquid nitrogen bath.
23) Place the Gatan CT3500 Cryotransfer Device (Gatan Model Number CT3500) into the Gatan Specimen Workstation.
24) Fill the liquid nitrogen dewar on the Gatan CT3500 Cryotransfer device and fill the dewar on the Gatan Specimen Workstation replenishing the liquid nitrogen as necessary until rapid boiling of the liquid nitrogen stops.
25) Transfer the Flat Specimen Holder to the Gatan Specimen Workstation while keeping it in a container of liquid nitrogen.
26) Using tweezers cooled in liquid nitrogen until the liquid nitrogen stops boiling, place the flat specimen holder into the Gatan Planchette Collet (Gatan P/N PEP5099) and press down firmly.
27) Place the assembly from step 26 into the Gatan Planchette Specimen Holder (Gatan P/N PEP1395) and press down firmly.
28) Push the Gatan Cryotransfer device back into the Gatan Specimen Workstation.
29) Using the Gatan supplied 5 mm Friction Tool, screw the Gatan Planchette Specimen Holder into the Gatan Cryotransfer device.
30) Remove the Gatan Cryotransfer device from the Gatan Specimen Workstation and insert it into the Gatan Alto 2500 Cryotransfer System.
31) Attach the Gatan ITC Temperature Controller (Gatan Model Number ITC502) to the Gatan Cryotransfer device by attaching the Temperature Measurement Lead from the Gatan ITC controller to the connector on top of the Gatan Cryotransfer device.
32) Using the Gatan ITC Controller, raise the temperature of the specimen to −120° C.
33) Using the fracturing knife, break off the copper washer to fracture the specimen.
34) Reduce the temperature of the specimen below −160° C.
35) With the voltage set to 6 KV and the gas flow set to provide 10 mA sputter current, press the sputter button and once the current displays 10 mA, let the coater run for 60-90 seconds coating the specimen with gold/palladium.
36) Close the frost shield on the Gatan CT3500 Cryotransfer Device and transfer the specimen to the Hitachi S-5200 SEM/STEM.
37) Wait for the temperature of the Gatan CT3500 Cryotransfer device to stabilize, typically between −170° C. and −172° C.
38) Open the frost shield on the Gatan CT3500 Cryotransfer device by turning the frost shield control knob counter-clockwise.
39) Move the sample around using the stage control trackball, locate a broken microcapsule and adjust the magnification to 50,000 to 150,000×.
40) Adjust the focus and stigmation controls to obtain the best image.
41) Acquire an image of the cross-section of the capsule wall.

Calculations
1) Select the ruler tool in the Quartz PCI software.
2) Move the cursor to one edge of the microcapsule wall.
3) Click and hold the left mouse button while dragging the mouse cursor to the opposite side of the capsule wall keeping the drawn line perpendicular to the face of the capsule wall to measure the wall thickness.
4) Use 50 independent measurements (1 measurement for each capsule) to calculate the percentage of particles having a wall thickness in the claimed range.

(4) Water Solubility Test

Water solubility is measured using ASTM method E1148-02 (2008)

(5) Water Soluble Benefit Agent Release Test

Material and instruments needed:
1. launder-o-meter (launder-o-meter procedures are described in the Technical Manual of the AATCC)
2. Test pieces of soiled fabric 10×10 cm as described in JAOCS, Vol. 66, n. 1 (January 1989)
3. A canister of 50 steel balls of 6 mm diameter
4. Industrial water (2.5 mmol/L hardness)
5. Detergent composition containing particles having a core comprising a benefit agent.

### Procedure:

Prepare a stainless-steel launder-o-meter container and add 250 mL of water at 30° C., 2.5 grams of a liquid detergent composition containing particles containing a benefit agent, three test pieces of soiled fabric 10×10 cm and 50 steel balls. Containers are place in the launder-ometer and they are rotated for 40 minutes at 42 rpm. After 5, 8 and 10 minutes a sample is taken for analytical measurement of the benefit agent. The analysis is preformed in accordance with the applicable protocol that is listed below:
A. Analytical test for hydrogen peroxide sources: Hydrogen peroxide in liquid bleaches liberates iodine from an acified potassium iodide solution. The free iodine is titrated potentiometrically with a standardized thiosulphate solution

Bleach component+2I⁻+2H⁺→I₂+2H₂O [1]

I₂+I⁻ [symbol] I₃⁻ [2]

I₃⁻+2S₂O₃2⁻→3I⁻+S₄O₆ [3]

Equipment:
Autotitrator (fe Metrohm 809) connected to a PC
Redox electrode (fe Metrohm 6.0431.100)

Chemicals:
Glacial Acetic Acid (VWR 1.00063)
KI 3 M (Sigma Aldrich 35175)
Na₂S₂O₃ 0.01 N (38243, Sigma Aldrich)
10% Sodium percarbonate aqueous solution. In order to prepare this solution, we add 100 grams sodium carbonate (VWR ALFAA16045) to 900 mL demi-water under continuous stirring.

Procedure:
a. weigh x grams of sample in order to have between 0.05 and 0.40 grams of pure material.
b. Add 50 mL water
c. Add 10 mL of acetic acid.
d. Stir for 1 minute
e. Add 4 mL of KI solution
f. Titrate with Na₂S₂O₃ with the redox electrode until the first equivalent point
g. Calculate the amount of peroxide:

$$\% Peroxides = \frac{V \cdot N \cdot {M}_{w}}{G \cdot 20}$$

wherein V is the measured volume in mL, N is the normality of the sodium thiosulfate solution, Mw the molecular weight of the hydrogen peroxide source and G the grams, based on 100% purity, of the hydrogen peroxide source weight for the titration
B. Analytical test for metal catalysts: Photometric method

The activity of the bleach catalyst is measured by means of a colorimetric reaction with a specific dye.
a. Preparation of a calibration curve: Add 40 μL of a 10.000 ppm detergent solution like the ones described in examples 13, 14 and 15, without particles containing X ppm of the metal catalyst in deionized water to 150 μL of Chicago sky blue reagent and incubate at 37° C. for 3 minutes (see table below). After incubation an absorbance measure of the solution of detergent and dye is made at 600 nm (Abs 1). Add 60 μL of the hydrogen peroxide reagent to the solution and incubate at 37° C. for 30 minutes. Measure the absorbance of this solution at 600 nm after incubation (Abs 2). Repeat this with different levels of metal catalyst according to following table:

| | X ppm metal | | | |
|---|---|---|---|---|
| Sample | catalyst | Abs 1 | Abs 2 | ABS = Abs 1 − Abs 2 |
| 0 | 0 | | | |
| 1 | 0.05 | | | |
| 2 | 0.10 | | | |
| 3 | 0.20 | | | |
| 4 | 0.30 | | | |
| 5 | 0.40 | | | |
| 6 | 0.50 | | | |
| 7 | 0.60 | | | |
| 8 | 0.80 | | | |
| 9 | 1.00 | | | |
| 10 | 1.25 | | | |
| 11 | 1.50 | | | |
| 12 | 1.75 | | | |
| 13 | 2.00 | | | |
| 14 | 2.50 | | | |
| 15 | 3.00 | | | |

Subtract the initial measured absorbance (Abs 1) from the final (Abs 2) and plot a calibration curve (polynomial fit).
b. Measure 40 μL of the sampled wash solution and determine the concentration of metal catalyst in the wash by using the calibration curve.
c. Determine the percentage of release:

$$\% Release = \frac{{C}_{wash}}{{C}_{total}} \times 100$$

wherein C_{wash} is the concentration determined in the wash in ppm and Cₜₒₜₐₗ is the total amount of metal catalyst in the wash in ppm (total encapsulated).
C. Analytical test for Enzymes: Enzyme content is measured using ASTM method D0348-89 (2003).

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### Making an Encapsulate

In a jacketed reactor, 271 grams of Norpar 12 Fluid (a mixture of normal paraffins from Exxon Mobil) and 13.5 grams of sorbitan monooleate (Span 80 from Sigma-Aldrich, St Louis, Mo., U.S.A.) are combined while mixing. In a separate beaker, an aqueous solution to be used as the internal phase (IP) of the microcapsules is prepared by combining 124 grams of deionized water, 30 grams of melamine formaldehyde resin (Cymel 385 from Cytec Industries, West Paterson N.J., U.S.A.), and 30 grams of water soluble manganese complex, such as of meso-5,5,7,12,12,14-hexamethyl-1,4,8,11-tetraazacyclotetradecane and racemic-5,5,7,12,12,14-hexamethyl-1,4,8,11-tetraazacyclotetradecane ligands. The pH of the solution is adjusted to 5.7 with a 10% phosphoric acid solution. The IP solution is then emulsified into Norpar 12 Fluid with a mechanical mixer at 1600 rpm for 10 minutes, and a stable water-in-oil emulsion is obtained. 5 grams of dialkylbenzene sulfonic acid is added into the reactor, and temperature of the reactor is set up to 45° C. and maintained at this temperature for at least 30 minutes, preferably 1, 2, 4 or even 8 hours with continuous stirring to complete the encapsulation. A slurry of water soluble benefit agent-containing microcapsules suspended in Norpar 12 Fluid with mean size of around 15 microns is obtained.

### Example 2

### Making an Encapsulate

The composition and the procedures for preparing the microcapsules are the same as in Example 1 except that dialkylbenzene sulfonic acid (DABSA) is replaced by Aristonic Acid L (Pilot Chemical Company, Cincinnati, Ohio).

### Example 3

### Making an Encapsulate

The composition and the procedures for preparing the microcapsules are the same as in Example 1 except that DABSA is replaced by Aristonic Acid H (Pilot Chemical Company, Cincinnati, Ohio).

### Example 4

### Making an Encapsulate

The composition and the procedures for preparing the microcapsules are the same as in Example 1 except that DABSA is replaced by Dupont Nafion™ powders (fluorinated sulfonic acid copolymers).

### Example 5

### Making an Encapsulate

The composition and the procedures for preparing the microcapsules are the same as in Example 1 except that DABSA is replaced by Dowex™ powders (Dow Chemical Company, Midland, Mich.).

### Example 6

### Making an Encapsulate

The composition and the procedures for preparing the microcapsules are the same as in Example 1 except that DABSA is replaced by p-toluenesulfonic acid (Sigma-Aldrich, St Louis, Mo., U.S.A.).

### Example 7

### Making an Encapsulate

The composition and the procedures for preparing the microcapsules are the same as in Example 1 except that Span 80 is replaced by Arlacel P135 (Uniqema, Paterson, N.J., U.S.A.).

### Example 8

### Making an Encapsulate

The composition and the procedures for preparing the microcapsules are the same as in Example 1 except that Norpar 12 Fluid is replaced by Isopar M (ExxonMobil, Houston, Tex., U.S.A.).

### Example 9

### Making an Encapsulate

The composition and the procedures for preparing the microcapsules are the same as in Example 1 except that Norpar 12 Fluid is replaced by Isopar L (ExxonMobil, Houston, Tex., U.S.A.).

### Example 10

### Making an Encapsulate

The composition and the procedures for preparing the microcapsules are the same as in Example 1 except that Norpar 12 Fluid is replaced by SAS 310 (Nisseki Chemical Texas, Inc., Pasadena, Tex., U.S.A.).

### Example 11

### Making an Encapsulate

The composition and the procedures for preparing the microcapsules are the same as in Example 1 except that Norpar 12 Fluid is replaced by SOYGOLD 1100 (AG Environmental Products, L.L.C., Omaha, Nebr., U.S.A.).

### Example 12

### Making an Encapsulate

The microcapsule slurry prepared in Example 1 can be optionally dried for powders. The prepared slurry is left to settle in the reactor for 8 hours, and the capsules form a cake at the bottom of the reactor and Norpar-12 Fluid form a supernatant on the top layer. After the supernatant layer is decanted, 200 grams of hexane is added to the reactor, and the capsules are re-suspended into the hexane to wash off the residual Norpar 12 Fluid in the cake. The hexane is filtered off with a filter paper in a funnel, and the filtered cake thus obtained is dried in a drying tray to obtain dry powders.

### Example 13

### Liquid Laundry Formulations (HDLs)

Non-limiting examples of product formulations containing an encapsulated solid water soluble benefit agent summarized in the following table

| Ingredient | HDL 1 | HDL 2 | HDL 3 | HDL 4 | HDL 5 | HDL 6 |
|---|---|---|---|---|---|---|
| Alkyl Ether Sulphate | 0.00 | 0.50 | 12.0 | 12.0 | 6.0 | 7.0 |
| Dodecyl Benzene | 8.0 | 8.0 | 1.0 | 1.0 | 2.0 | 3.0 |
| Sulphonic Acid | | | | | | |
| Ethoxylated Alcohol | 8.0 | 6.0 | 5.0 | 7.0 | 5.0 | 3.0 |
| Citric Acid | 5.0 | 3.0 | 3.0 | 5.0 | 2.0 | 3.0 |
| Fatty Acid | 3.0 | 5.0 | 5.0 | 3.0 | 6.0 | 5.0 |
| Ethoxysulfated | 1.9 | 1.2 | 1.5 | 2.0 | 1.0 | 1.0 |
| hexamethylene diamine | | | | | | |
| quaternized | | | | | | |
| Diethylene triamine penta | 0.3 | 0.2 | 0.2 | 0.3 | 0.1 | 0.2 |
| methylene phosphonic acid | | | | | | |
| Enzymes | 0.8 | 0.0 | 0 | 0.0 | 1.2 | 0.0 |
| Brightener (disulphonated | 0.14 | 0.09 | 0 | 0.14 | 0.01 | 0.09 |
| diamino stilbene based | | | | | | |
| FWA) | | | | | | |
| Cationic hydroxyethyl | 0 | 0 | 0.10 | 0 | 0.200 | 0.30 |
| cellulose | | | | | | |
| Poly(acrylamide-co- | 0 | 0 | 0 | 0.50 | 0.10 | 0 |
| diallyldimethylammonium | | | | | | |
| chloride) | | | | | | |
| Thickener | 0.50 | 0.44 | 0.2 | 0.2 | 0.3 | 0.3 |
| Boric acid | 2.4 | 0.0 | 0.0 | 0.0 | 1.0 | 0.0 |
| Ethanol | 0.0 | 1.0 | 0.0 | 0.5 | 1.0 | 1.0 |
| 1,2 propanediol | 2.5 | 3.0 | 3.0 | 2.5 | 0.01 | 0.01 |
| Glutaraldehyde | 0 | 0 | 19 ppm | 0 | 13 ppm | 0 |
| Diethyleneglycol (DEG) | 1.6 | 0 | 0 | 0 | 0 | 0 |
| 2,3-Methyl-1,3- | 1.0 | 1.0 | 0 | 0 | 0 | 0 |
| propanediol (M pdiol) | | | | | | |
| Mono Ethanol Amine | 1.0 | 0.5 | 0 | 0 | 0 | 0 |
| NaOH Sufficient To | pH 8 | pH 8 | pH 8 | pH 8 | pH 8 | pH 8 |
| Provide Formulation pH of: | | | | | | |
| Sodium Cumene | 2.00 | 0 | 0 | 0 | 0 | 0 |
| Sulphonate (NaCS) | | | | | | |
| Silicone (PDMS) emulsion | 0.003 | 0.003 | 0.003 | 0.003 | 0.003 | 0.003 |
| Amine* | 0.0 | 0.10 | 0.0 | 0.0 | 0.0 | 0.0 |
| Perfume composition | 0.0 | 0.0 | 0.4 | 0.0 | 0.0 | 0.0 |
| Encapsulated solid water | 1.7 | 3.4 | 2.5 | 1.3 | 0.9 | 1.2 |
| soluble benefit agent^{a} | | | | | | |
| Water | Balance | Balance | Balance | Balance | Balance | Balance |

*One or more materials comprising an amine moiety as disclosed in the present specification.
^{a}slurry of encapsulated water soluble manganese complex, such as of meso-5,5,7,12,12,14-hexamethyl-1,4,8,11-tetraazacyclotetradecane and racemic-5,5,7,12,12,14-hexamethyl-1,4,8,11-tetraazacyclotetradecane ligands

### Example 14

### Dry Laundry Formulations

Non-limiting examples of product formulations containing particles of the aforementioned examples are summarized in the following table.

| | % w/w granular laundry detergent composition | | | | | | |
|---|---|---|---|---|---|---|---|
| Component | A | B | C | D | E | F | G |
| Brightener | 0.1 | 0.1 | 0.1 | 0.2 | 0.1 | 0.2 | 0.1 |
| Soap | 0.6 | 0.6 | 0.6 | 0.6 | 0.6 | 0.6 | 0.6 |
| Ethylenediamine disuccinic acid | 0.1 | 0.1 | 0.1 | 0.1 | 0.1 | 0.1 | 0.1 |
| Acrylate/maleate copolymer | 1.5 | 1.5 | 1.5 | 1.5 | 1.5 | 1.5 | 1.5 |
| Hydroxyethane di(methylene | 0.4 | 0.4 | 0.4 | 0.4 | 0.4 | 0.4 | 0.4 |
| phosphonic acid) | | | | | | | |
| Mono-C₁₂-C₁₄ alkyl, di-methyl, | 0.5 | 0.5 | 0.5 | 0.5 | 0.5 | 0.5 | 0.5 |
| mono-hydroyethyl quaternary | | | | | | | |
| ammonium chloride | | | | | | | |
| Linear alkyl benzene | 0.1 | 0.1 | 0.2 | 0.1 | 0.1 | 0.2 | 0.1 |
| Linear alkyl benzene sulphonate | 10.3 | 11.1 | 19.9 | 14.7 | 10.3 | 17 | 10.5 |
| Magnesium sulphate | 0.4 | 0.4 | 0.4 | 0.4 | 0.4 | 0.4 | 0.4 |
| Sodium carbonate | 19.5 | 19.2 | 9.8 | 18.5 | 29.9 | 10.1 | 16.8 |
| Sodium sulphate | 29.6 | 29.8 | 38.8 | 15.1 | 23.9 | 19.5 | 19.1 |
| Sodium Chloride | 0.1 | 0.1 | 0.1 | 0.1 | 0.1 | 0.1 | 0.1 |
| Zeolite | 9.6 | 9.4 | 7.5 | 18 | 10 | 13.2 | 17.3 |
| Photobleach particle | 0.1 | 0.1 | 0.2 | 0.1 | 0.2 | 0.1 | 0.2 |
| Blue and red carbonate speckles | 1.8 | 1.8 | 1.8 | 1.8 | 1.8 | 1.8 | 1.8 |
| Ethoxylated Alcohol AE7 | 1 | 1 | 1 | 1 | 1 | 1 | 1 |
| Tetraacetyl ethylene diamine | 0.9 | 0.9 | 0.9 | 0.9 | 0.9 | 0.9 | 0.9 |
| agglomerate (92 wt % active) | | | | | | | |
| Citric acid | 1.4 | 1.4 | 1.4 | 1.4 | 1.4 | 1.4 | 1.4 |
| PDMS/clay agglomerates (9.5% | 10.5 | 10.3 | 5 | 15 | 5.1 | 7.3 | 10.2 |
| wt % active PDMS) | | | | | | | |
| Polyethylene oxide | 0.2 | 0.2 | 0.2 | 0.2 | 0.2 | 0.2 | 0.2 |
| Enzymes e.g. Protease (84 mg/g | 0.2 | 0.3 | 0.2 | 0.1 | 0.2 | 0.1 | 0.2 |
| active), Amylase (22 mg/g active) | | | | | | | |
| Suds suppressor agglomerate | 0.2 | 0.2 | 0.2 | 0.2 | 0.2 | 0.2 | 0.2 |
| (12.4 wt % active) | | | | | | | |
| Sodium percarbonate (having | 7.2 | 7.1 | 4.9 | 5.4 | 6.9 | 19.3 | 13.1 |
| from 12% to 15% active AvOx) | | | | | | | |
| Perfume oil | 0.5 | 0.5 | 0.5 | 0.5 | 0.5 | 0.5 | 0.5 |
| Solid perfume particles | 0.6 | 0.4 | 0 | 0.4 | 0.4 | 0.4 | 0.5 |
| Particles* | 0.3 | 0.1 | 2.4 | 1.3 | 1.8 | 1.5 | 0.8 |
| Water | 1.4 | 1.4 | 1.4 | 1.4 | 1.4 | 1.4 | 1.4 |
| Misc | 0.9 | 1.0 | 0.0 | 0.1 | 0.1 | 0.1 | 0.1 |
| Total Parts | 100 | 100 | 100 | 100 | 100 | 100 | 100 |

*Particles like the ones made in example 12

### Example 15

### Liquid Unit Dose

The following are examples of unit dose executions wherein the liquid composition is enclosed within a PVA film. The preferred film used in the present examples is Monosol M8630 76 μm thickness.

| | D | | | E | | F | | |
|---|---|---|---|---|---|---|---|---|
| | 3 compartments | | | 2 compartments | | 3 compartments | | |
| Compartment # | 42 | 43 | 44 | 45 | 46 | 47 | 48 | 49 |
| Dosage (g) | 34.0 | 3.5 | 3.5 | 30.0 | 5.0 | 25.0 | 1.5 | 4.0 |
| Ingredients | Weight % | | | | | | | |
| Alkylbenzene sulfonic | 20.0 | 20.0 | 20.0 | 10.0 | 20.0 | 20.0 | 25 | 30 |
| acid | | | | | | | | |
| Alkyl sulfate | | | | 2.0 | | | | |
| C₁₂₋₁₄ alkyl 7- | 17.0 | 17.0 | 17.0 | | 17.0 | 17.0 | 15 | 10 |
| ethoxylate | | | | | | | | |
| C₁₂₋₁₄ alkyl ethoxy 3 | 7.5 | 7.5 | 7.5 | | | 7.5 | 7.5 | |
| sulfate | | | | | | | | |
| Citric acid | 0.5 | | 2.0 | 1.0 | | | | 2.0 |
| Zeolite A | | | | 10.0 | | | | |
| C₁₂₋₁₈ Fatty acid | 13.0 | 13.0 | 13.0 | | 18.0 | 18.0 | 10 | 15 |
| Sodium citrate | | | | 4.0 | 2.5 | | | |
| enzymes | 0-3 | 0-3 | 0-3 | 0-3 | | 0-3 | 0-3 | 0-3 |
| Sodium Percarbonate | | | | 11.0 | | | | |
| TAED | | | | 4.0 | | | | |
| Polycarboxylate | | | | 1.0 | | | | |
| Ethoxylated | 2.2 | 2.2 | 2.2 | | | | | |
| Polyethylenimine¹ | | | | | | | | |
| Hydroxyethane | 0.6 | 0.6 | 0.6 | 0.5 | | | 2.2 | |
| diphosphonic acid | | | | | | | | |
| Ethylene diamine | | | | | | 0.4 | | |
| tetra(methylene | | | | | | | | |
| phosphonic) acid | | | | | | | | |
| Brightener | 0.2 | 0.2 | 0.2 | 0.3 | | 0.3 | | |
| Particles² | 0 | 0.1 | 0 | 0 | 1.3 | 0.4 | 1.5 | 0.2 |
| Water | 9 | 8.5 | 10 | 5 | 11 | 10 | 10 | 9 |
| CaCl2 | | | | | | | 0.01 | |
| Perfume | 1.7 | 1.7 | | 0.6 | | 1.5 | 0.5 | |
| Minors (antioxidant, | 2.0 | 2.0 | 2.0 | 4.0 | 1.5 | 2.2 | 2.2 | 2.0 |
| sulfite, aesthetics, . . .) | | | | | | | | |

| | |
|---|---|
| Buffers (sodium | To pH 8.0 for liquids |
| carbonate, | To RA >5.0 for powders |
| monoethanolamine)³ | |
| Solvents (1,2 | To 100p |
| propanediol, ethanol), | |
| Sulfate | |

¹Polyethylenimine (MW = 600) with 20 ethoxylate groups per —NH.
³RA = Reserve Alkalinity (g NaOH/dose)
²Particles added as 2-10% active slurry (aqueous solution, after removing the water insoluble phase) of encapsulated water soluble manganese complex, such as of meso-5,5,7,12,12,14-hexamethyl-1,4,8,11-tetraazacyclotetradecane and racemic-5,5,7,12,12,14-hexamethyl-1,4,8,11-tetraazacyclotetradecane ligands

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product comprising:
a. particles, said particles comprising a shell material and a core material, said shell material encapsulating said core material and comprising a material selected from cross-linked melamine formaldehyde, cross-linked urea formaldehyde and mixtures thereof, said core material comprising a solution comprising water and a water soluble benefit agent having a water solubility of at least 10 g/liter; and
b. a consumer product adjunct ingredient;
wherein at least 75% of said particles have a fracture strength of from about 0.1 MPa to about 5 MPa.

2. A consumer product according to claim 1, said core material comprising, based on total core weight, from about 0.01% to about 80% of said water soluble benefit agent.

3. A consumer product according to claim 1, said particle comprising, based on total particle weight, from about 1% to about 95% of said core material.

4. A consumer product according to claim 1, said consumer product comprising, based on total consumer product weight, from about 0.01% to about 50% of said particle.

5. A consumer product according to claim 1, wherein said water soluble benefit agent comprises a material selected from the group consisting of a metal catalyst, a hydrogen peroxide source, an enzyme and mixtures thereof.

6. A consumer product according to claim 5, wherein:
a. said metal catalyst comprises a material selected from the group consisting of dichloro-1,4-diethyl-1,4,8,11-tetraaazabicyclo[6.6.2]hexadecane manganese(II); dichloro-1,4-dimethyl-1,4,8,11-tetraaazabicyclo[6.6.2]hexadecane manganese(II) and mixtures thereof;
b. said hydrogen peroxide source comprises a material selected from the group consisting of a perborate, a percarbonate a peroxyhydrate, a peroxide, a persulfate, hydrogen peroxide and mixtures thereof; and
c. said enzyme comprises a material selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

7. A consumer product according to claim 1, wherein said consumer product has a benefit agent release of at least 10% of said water soluble benefit agent after 10 minutes of use of such consumer product containing said particles.

8. A consumer product according to claim 1, wherein at least 75% of said particles have a particle size of from about 1 micron to about 100 microns.

9. A consumer product according to claim 1, wherein at least 75% of said particles have a particle wall thickness of from about 5 nm to about 250 nm.

10. A consumer product according to claim 1, said consumer product further comprising a material selected from the group consisting of a formaldehyde scavenger, a structurant, an anti-agglomeration agent and mixtures thereof.

11. A consumer product according to claim 1, said consumer product comprising, based on total consumer product weight, less than 85% total water.

12. A consumer product according to claim 1, said consumer product comprising, based on total consumer product weight, from about 1% to about 85% total water.

13. A process of making a consumer product comprising a consumer product adjunct material and particles that comprise a shell material and a core material encapsulated by said shell material, said process comprising:
a) providing an aqueous phase comprising water and a water soluble benefit agent;
b) dissolving or dispersing shell-forming material comprising water-soluble or water-dispersible prepolymers, oligomers or monomers into the aqueous phase;
c) providing a water-immiscible phase comprising a curable monomer or oligomer and at least one emulsifier;
d) dispersing the aqueous phase into an excess of the water immiscible phase under high shear agitation to form droplets of the aqueous phase dispersed in the water immiscible phase, a water-oil interphase resulting at the interphase of the aqueous and water-immiscible phases;
e) adding at least one water insoluble polymerization catalyst reactive with the shell forming prepolymers, oligomers or monomers present in the aqueous phase;
f) forming particles by initiating polycondensation of the monomers, oligomers or prepolymers in the dispersed aqueous phase by heating to precipitate the monomers, oligomers and prepolymers from the aqueous phase at the water-oil interphase, thereby forming the shell material that at least partially encapsulates the droplets of the aqueous phase and core material; and
g) combining said particles with said consumer product adjunct material.

14. The process of making a consumer product according to claim 13, wherein the particles are microcapsules and the shell material encapsulates the droplets of the aqueous phase and the water soluble benefit agent.

15. The process of making a consumer product according to claim 13, wherein said water soluble benefit agent comprises a material selected from the group consisting of a metal catalyst, a hydrogen peroxide source, an enzyme and mixtures thereof.

16. The process of making a consumer product according to claim 13, wherein the water insoluble polymerization catalyst is selected from an acid, a phase transfer catalyst, and a proton transfer catalyst.

17. The process of making a consumer product according to claim 16, wherein the water insoluble polymerization catalyst comprises sulfonic acid.

18. The process of making a consumer product according to claim 16, wherein the water insoluble polymerization catalyst is selected from the group consisting of mono- or di-alkylbenzene sulfonic acid, alkaryl sulfonic acid, alkali metal salts of hydrocarbon sulfonic acids, oil soluble sulfonic acids, salts of hydrophobic sulfonic acids, and halogenated sulfonic acid copolymers.

19. The process of making a consumer product according to claim 16, wherein the water insoluble polymerization catalyst is a fluorinated sulfonic acid copolymer particle or an acid cation ion exchange particle.

20. The process of making a consumer product according to claim 13, wherein at least one shell-forming prepolymer is also dispersed into the water immiscible solvent.

21. The process of making a consumer product according to claim 20, wherein the shell-forming prepolymer is selected from urea formaldehyde, melamine formaldehyde, novolac, and phenolic resin.

22. The process of making a consumer product according to claim 13, wherein the water immiscible phase includes an organic solvent.

23. The process of making a consumer product according to claim 13, further including the step of decanting the formed particles from the water immiscible phase.
